(19) United States
(12) Patent Application Publication
(10) Pub. No.: US 2007/0135942 A1
(43) Pub. Date: Jun. 14, 2007

(54) Electrical Component Monitoring System

(76) Inventors: Peter F. Werner, Toronto (CA); Bernard Wasserman, Thornhill (CA); Vasile D. Dobreanu, North York (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 11/457,922

(22) Filed: Jul. 17, 2006

(30) Foreign Application Priority Data
Dec. 14, 2005 (CA) 2530781

(51) Int. Cl. G05B 13/02

(52) U.S. Cl. 700/32

(57) ABSTRACT

A motor control centre is provided having an analyst system which is capable of recording data from the monitoring equipment provided therein, and providing a predictive analysis of the data received. The predictive analysis allows the operator to have the ability to schedule routine maintenance to correct a predicted failure of a device to continue operation within a pre-determined set of parameters. Improved operation and maintenance of a controlled system is achieved.

### FIELD OF THE INVENTION

The present invention relates generally to the field of monitoring electrical components, and in particular, to a method and apparatus which provides for the analysis of electrical component operational functionality in order to determine the electrical component's operational status, and to make predictive analysis related to the component or to advise of the need for preventive maintenance or replacement of the component.

### BACKGROUND OF THE INVENTION

Increasing automation in control and monitoring systems has lead to enhancements in the flexibility and programmability of various components. Early programmable logic controllers (PLCs), for example, permitted manual input of logic programs, largely replacing conventional relay panels. Further developments allowed for more sophisticated programming of controllers, as well as limited programming of individual components.

Where limited programmability is provided in conventional industrial automation systems, these devices must generally be manually programmed individually. Thus, prior to assembly of an integrated system, or following such assembly, technicians and operators would manually input configuration parameters, settings, node addresses, and the like into the various programmable components. This programming procedure was not only costly in terms of time and manpower, but led to errors in the input process which would later need to be identified and corrected. Following initial programming, such systems were also not particularly well-suited to reprogramming or reconfiguration since they would require similar manual and individual data input.

More recently, a wide range of electrical device controllers would be assembled and interconnected into panels, cabinetry, enclosures, and the like, to form an electrical component assembly. In one type of electrical controller assembly, commonly referred to as a motor control center (or “MCC”), power and data signals are exchanged between panel-mounted components and external circuitry.

Typical of this type of controller assembly, standardized wiring is provided for routing wiring to the various controller components mounted in the enclosure. Thus, in a preferred design, standardized controller components could be inserted into standardized bays within the enclosure, and then similarly rapidly connected to the monitoring equipment also enclosed therein.

Many types of electrical components could be included as being controlled by the controllers in an MCC type controller assembly. This might include any electrical device that would provide a measurable parameter, including for example, electric motors, valves, actuators or the like. Parameters which might be measured include voltages, current, start-up times, or the like.

In order to monitor the data from this type of arrangement, the MCC or, more generally, the controller assembly, is connected to a separate central control unit which would receive the raw data from the monitoring equipment. While this would provide an adequate ability to review the data in detail in a simple installation, this design can quickly be overwhelmed with information. In even routine configurations, it is possible that a typical MCC controller might include control functions for up to 50 or 60 or more electrical components, and that in a large scale plant or industrial operation, numerous MCC controllers might be utilized. As such, the amount of data to be transferred to the central control unit would be significant. Further, the analysis of the data is dependent on the data reaching the central controller unit. Should there be a transmission system disruption, the data to or from the controller assembly would be lost.

As such, the amount of data being sent to the central controller unit would preclude any meaningful, real-time analysis of the data with respect to being able to predict the future performance of the device. At best, the central controller unit would be able to determine whether the device was operating within acceptable operational parameters, and alert an operator once the device has begun operating outside of these parameters.

More in-depth monitoring and/or analysis of the performance of the components of a motor control system might be accomplished by temporarily connecting a computerized system, such as a personal computer (or PC) to single controller monitor present in a controller assembly, in order to monitor the status of a selected component. Using this arrangement, it would be possible to collect more detailed data on the performance of a component being monitored, and possibly determine if an abnormal situation exists or develops in a device (such as a motor failure).

However, this approach is not practical to study the long-term performance of a number of controllers within a controller assembly, let alone a situation where numerous controller assemblies are present. In order to achieve this result, a significant number of PCs would be required to monitor each, or a limited number of controllers, on a short term basis.

While this type of system can provide the ability to monitor a number of MCCs from a common location using a single computer system, it would be advantageous to improve on this system.

A further disadvantage of the use of a central controller unit is that the addition of additional controller assemblies, or MCCs, to an existing system, or the modification of equipment within a controller assembly, can require extensive modification to the programing of the central controller unit in order to correctly interpret the information from the newly added, or modified controller. As a result, it may be necessary to undergo an expensive re-programing session, and/or require downtime of the entire central controller unit while the central controller unit system is upgraded or otherwise modified.

As such, it would be advantageous to provide an MCC monitoring system which avoided or ameliorated the disadvantages of the prior art monitoring systems.

### SUMMARY OF THE INVENTION

The present invention therefore provides a novel device and approach to monitoring the various controller components which are utilized in an industrialized setting. The approach may be applied in a wide range of systems, but is well-suited to industrial automation, and is particularly well-suited to electrical power controller components, including controllers operating electrical devices such as motors, motor starters, motor drives, programmable relays, and so forth.

Further, the approach is of particular use in the monitoring of the various controller components incorporated within, or otherwise connected to, a controller assembly, and in particular, a motor control centre (or MCC).

Accordingly, the advantages set out hereinabove, as well as other objects and goals inherent thereto, are at least partially or fully provided by the electrical component monitoring system and apparatus of the present invention, as set out herein below.

Accordingly, in one aspect, the present invention provides a controller assembly comprising at least one controller for controlling a device, at least one monitoring component associated with either or both of said controller or said device, in order to collect data related to an operational parameters of said device, and a local analyst system for analysing the data collected relating to said operational parameter in order to evaluate the performance of said device. Preferably, the analyst system comprises a database of information related to acceptable operational parameter limits for said device, a system for comparing said data to said operational parameter limits, and an alert system for establishing an alarm should an operational parameter limit be exceeded. Additionally, or alternatively, the analyst system preferably comprises a database of historical data related to an operational parameter of said device, a database of acceptable operational limits, means for analysis of said historical data to determine or predict a future parameter value, and an alert system for establishing an alarm should it be predicted that an operational parameter limit will be exceeded within a pre-established time period.

The controller assembly is preferably a motor control center (MCC), and may comprise only 1 or a limited number of controller units, but might also comprise up to 50 to 70 controller components within a controller assembly. Most preferably, though, between 2 and 50 controller components are provided, and still more preferably, between 3 and 20 controller components provided. At least one controller component is monitored, and while some components need not be monitored, preferably all controller components are monitored by a monitoring component.

Optionally, the data collected by the monitor component, and/or information from the analyst system can be provided to a centralized monitoring station. However, this is not essential in the practise of the present invention. Further, this information can be transferred on demand, or on a lower priority basis such that it would not interfere with higher priority data from any of the assembly monitoring devices.

A key feature of the use of the analyst system is the provision of the ability to predict and determine future performance of the component being monitored. For example, the data collected by the analyst system can be statistically analysed to determine whether a trend exists for a change in an operational parameter. As one example, the current for a particular motor might be statistically observed to be increasing over time. Based on the analysis of the rise in current, the analyst system would provide an estimate of when the current of the motor would exceed a defined limit, and would be able to provide an alert that maintenance or replacement of the motor was imminent, or would be required in future. As a result, the data from the monitoring equipment can also be used to determine trends for a particular device in order to determine whether repair or replacement is necessary. Additionally, analysis of the collected data might also be able to determine more optimal or more efficient operating conditions, or the like.

### BRIEF DESCRIPTION OF THE DRAWINGS

Embodiments of this invention will now be described by way of example only in association with the accompanying drawings in which:

FIG. 1 is a front perspective view of an MCC enclosure

FIG. 2 is an enlarged view of a display unit on an MCC enclosure;

FIG. 3 is a schematic representation of a plurality of MCC enclosure opitionally connected to a central monitoring station; and

FIG. 4 is a representative overview of a flow chart showing the on-going analysis of the data from the component monitor.

### DETAILED DESCRIPTION OF THE PREFERRED EMBODIMENTS

In the present application, the term “motor control centre” or “MCC” refers to an enclosure known within the art, to include a variety of electrical control and monitoring devices. In the following discussion, reference will be made primarily to the use of the present invention when incorporated into a MCC controller assembly. However, the skilled artisan will be aware that the concepts of the present invention might be used in a wide variety of similar applications. Accordingly, while the present application will be described with particular reference to an MCC, the skilled artisan would be aware that the present application is equally applicable in other applications.

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

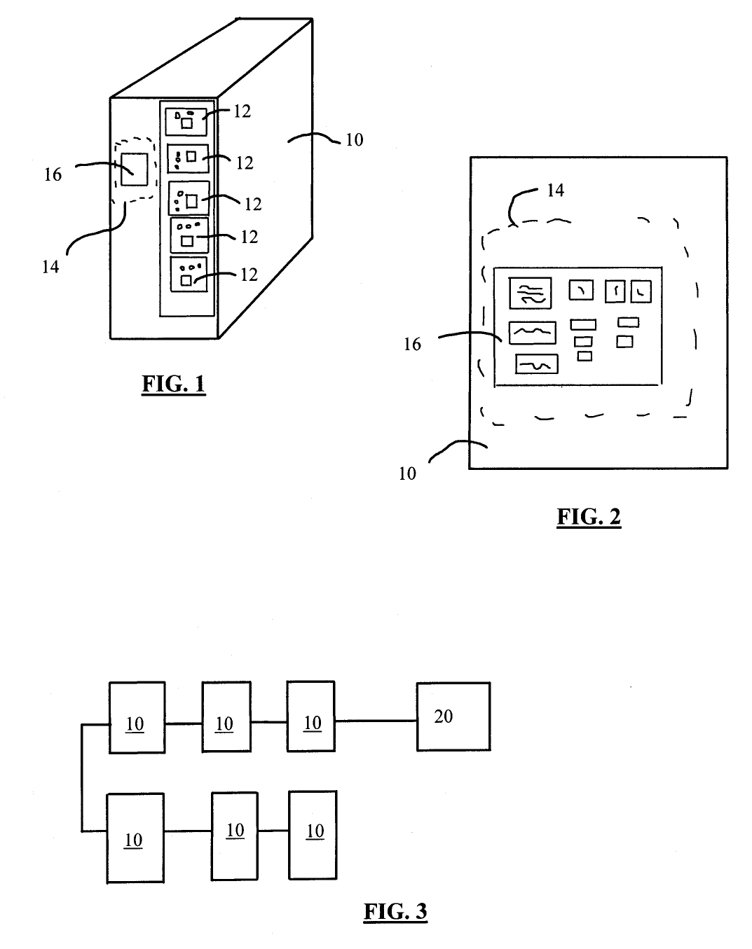

Referring to FIG. 1 a front perspective view of a typical MCC enclosure 10 acting as a controller assembly. Each enclosure 10 typically has a series of modules 12. In this case, five modules 12 are shown. While modules 12 may take many forms, and include devices for accomplishing many different and varied purposes, in a preferred implementation, modules 12 include electrical control equipment for regulating application of electrical power to a variety of electrical devices (or loads) which might include devices such as motors, motor starters, motor controllers, turbines, machine driven components such as pumps, compressors and fans, variable frequency drives, relays, protective devices such as circuit breakers, or any of a variety of devices. In addition, modules 12 and/or the MCC enclosure 10 also include monitoring components (not shown). The monitoring components monitoring the electrical equipment or components are typically also located with modules 12. In any given MCC enclosure 10, up to 70 or more controllers and monitoring components are provided, but more typically 10 to 15 controllers and monitoring components are provided.

The number of modules, controllers, and monitoring components will vary depending on the particular application. However, in a preferred embodiment, the modules have a standardized shape and size, particularly with respect to width and depth, so that they can be easily fitted within an MCC enclosure. Larger modules can be provided having an increased height, if needed.

Each monitoring component is connected to an local analyst system 14 which, in this embodiment, is a Human/Machine Interface, Programable Logic Controller (HIM/PLC), which is depicted, in this embodiment, as being associated with, or part of, display panel 16 on enclosure 10.

In FIG. 2, a display panel 16 is shown which provides an indication of the status of one electrical component currently being used in that particular MCC. The display can be used to display the current status of any monitored controller within the MCC, enclosure 10. Display 16 is also preferably used as an input device by acting as a touch-screen device. However, other input devices might be used including keyboards, mice or the like.

Local analyst system 14 can be any programable system but preferably is a programable logic computer (PLC) adapted to receive the information from the various monitoring components housed within the MCC. System 14 can be preprogramed to receive the input from a number of different types of modules 12, or the output from modules 12 can be adjusted to a standardized format. Preferably, system 14 and/or modules 12 are configured so that system 14 can identify the components of module 12 and select an appropriate display and control panel for that module.

For example, if module 12 is a water pump controller it will communicate with system 14 so that an appropriate display is shown, and the appropriate performance characteristics are monitored. A completely different display and monitor function might be provided should module 12 be used to control a non-critical air ventilation fan.

System 14 preferably contains a database of preprogramed display and monitor control characteristics such that a suitable display and monitor control functions can be automatically or manually selected from the system database. However, manual values for the parameter limits might also be manually inputted based on previous experience or suggested values from the component supplier, or the like.

The database in system 14 provides at least one set of controller parameter limits so that if the parameter limits are exceeded, system 14 would provide an alert. The parameters which can be monitored include, for example, voltage, current, load and other electrical values, but might also include parameters such as vibration, pressure or the like. When a parameter level (or rule) has been exceeded, system 14 provides an alert which could include any of a number of pre-programed events, such as sounding an alarm, initiating a flashing light, shut-down of various devices, or some other event, such as sending an e-mail message to a selected recipient.

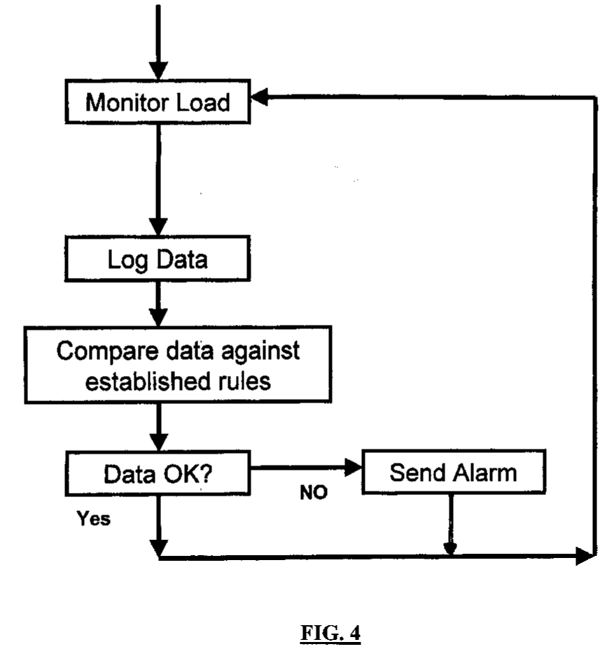

A flow chart showing the real-time analysis of the data from the monitoring component is shown in FIG. 4.

In the embodiment of FIG. 2, system 14 also includes the ability to store the real-time data received form the from the monitoring component and compare it to previous values in order to determine trends in the data from the monitored component. As such, a role of system 14 is to analyze and store the data from the monitoring component, determine (using statistically analysis of the data) whether a trend is developing, and advise an operator should a predicted non-compliant level of a parameter is anticipated. For example, if an analysis of a motor current indicates a recent rise in current over and above an expected range of current increase, then an alert might be sent to an operator to preform maintenance on the motor in the near future. Further, if statistical analysis of the current indicates a slow steady increase in current, then the system will advise an operator of the change in current in order to allow maintenance to be scheduled at an appropriate time.

The current data might be compared to data from recent observed values, or might be compared to data supplied from the manufacturer or supplier, or even to a database of data recorded when the device was known to be operating with acceptable design parameters, such as, for example, when the device was newly installed. As such, the acceptable parameter values used by the system might be “self-taught” by the system based on observed values. The operator or system can select which parameter limitation might best be used.

Each MCC or enclosure 10 is thus capable of analysing the information related to any or all of the monitoring components contained within enclosure 10, and provide information on the current status of the controller or controlled device. Each MCC or enclosure 10 is also able to provide predictive information on the controller or the controlled device, and thus allow the operator to be able to conduct preventive maintenance which might be required, prior to a failure of the device.

If desired, on a regular basis, system 14 can also transfer the data stored therein, to central monitoring station 20 for further analysis, or for long term storage, as shown in FIG. 3. Central monitoring station 20 might also be provided with the ability to connect to MCC 10 in order to adjust or modify the operational parameters, or to view the data from the monitoring component. However, the central monitoring station 20 is optional.

Using the arrangement of the present invention, modules can be easily added, removed, or replaced within an MCC enclosure, and additional monitoring components can be brought on-line with minimal disruption of the entire monitoring system. Also, these modifications can be made without the need for any significant program modification to a central monitoring system.

Thus, it is apparent that there has been provided, in accordance with the present invention, a electrical component monitoring system which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

We claim:

1. A controller assembly comprising at least one controller for controlling a device, at least one monitoring component associated with either or both of said controller or said device, in order to collect data related to an operational parameters of said device, and a local analyst system for analysing the data collected relating to said operational parameter in order to evaluate the performance of said device.

2. A controller assembly as claimed in claim 1 wherein said analyst system comprises a database of information related to acceptable operational parameter limits for said device, a system for comparing said data to said operational parameter limits, and an alert system for establishing an alarm when an operational parameter limit is exceeded.

3. A controller assembly as claimed in claim 1 wherein said analyst system additionally or alternatively comprises a database of historical data related to an operational parameter of said device, a database of acceptable operational limits, means for analysis of said historical data to determine or predict a future parameter value, and an alert system for establishing an alarm when it is predicted that an operational parameter limit will be exceeded.

4. A controller assembly as claimed in claim 3 wherein said parameter limit is predicted to be exceeded within a pre-established time period.

5. A controller assembly as claimed in claim 1 wherein said controller assembly is a motor control center (MCC).

6. A controller assembly as claimed in claim 1 wherein said device is an electrical power component.

7. A controller assembly as claimed in claim 6 wherein said electrical power component is selected from the group of motors, motor starters, motor drives, and programmable relays.

8. A controller assembly as claimed in claim 1 comprising up to 70 controller components.

9. A controller assembly as claimed in claim 8 comprising between 3 and 20 controller components.

10. A controller assembly as claimed in claim 1 wherein each controller component and/or each device, is monitored by a monitoring device.
